(19) United States
(12) Patent Application Publication
(10) Pub. No.: US 2011/0260980 A1
(43) Pub. Date: Oct. 27, 2011

(54) System for enhancing the utilization of touch screen devices

(76) Inventor: Angel Palacios, Madrid (ES)

(21) Appl. No.: 12/963,521

(22) Filed: Dec. 8, 2010

(30) Foreign Application Priority Data
Dec. 1, 2009 (ES) P200902265

(51) Int. Cl. G06F 3/02

(52) U.S. Cl. 345/168

(57) ABSTRACT

This invention presents a system for adding unevenness to keyboards in touch screens. Said unevenness will help the user to better perceive the keys on which she is placing her fingers, therefore helping her to type faster and with higher confidence and accuracy. There exist several ways to add said unevenness. In one of them, a thin sheet is placed upon the touch screen, said sheet comprising several openings or cavities. When the user moves her finger over said openings, she will, by her sense of touch, perceive the keys on which her finger is moving. The previous sheet can be transparent to allow seeing the keys located on the screen, but it can also be opaque if the keys are printed on top of it in corresponding position to the keys that are shown on the touch screen.

(This patent application claims international priority right after patent application P200902265 filed in Spain on Dec. 9, 2009)

### INDUSTRIAL FIELD

The current invention belongs to the area of consumer electronics, pore precisely of consumer informatics.

### PRIOR ART

The current tendency is installing touch screens in mobile phones and other computerized devices, including remote controls for TV sets. This way, the device acquires maximum versatility, because the system will show in the screen the controls that are appropriate for handling the application that is being run in each time. Besides, when it is not necessary to show any control, the screen will be used to show the user the maximum of information related to the utilization that is being used in that moment.

The main problem with devices that have touch screens is in entering text, and data in general. Typing in a touch screen is more difficult than in a conventional keyboard, mainly because the user does not receive enough sensorial information about where his/her fingers are located. That provokes, for example, that it is very difficult to use a touch screen phone with just one hand. Normally, users employ both hands, which can be uncomfortable in some circumstances. Besides, data entry is much slower. This second issue is very important for those who use email on the phone frequently.

This usually has two consequences:
1. Despite the great appeal of touch screens, manufacturers produce many phones with full keyboard, for example Blackberry 9000 and Nokia E71, which have the disadvantage that the screen size gets reduced. These devices are not cheap, which indicates that the reason to lack a touch screen is not to reduce costs, but facilitate usability.
2. Manufacturers produce phones with touch screen that also have a full keyboard in the interior, which can be moved out. These phones have the disadvantage that they are quite thicker (for example, Nokia N97). Besides, they are also difficult to use with a single hand, because the keyboard is usually horizontal and is prepared to be used with two hands. The recently release Palm Pre has the keyboard in vertical position, which facilitates the utilization with a single hand.

Attempts have been made to make the utilization of touch screen similar to the utilization of a conventional keyboard, but they have many limitations. For example, Nokia 5800 produces a vibration when a key has been pressed. In other example, Blackberry Storm is designed so that the screen depresses or moves inward slightly in order to simulate the depression that suffers a key when it is pressed.

A fundamental problem of keyboards in small devices is that, even though this depends on the format of the mobile phone, it is frequent that the finger tip covers up to four keys in the keyboard. The consequence of this is that the user is not sure about what key exactly his/her finger is at a given time.

Physical keyboards provide sensorial information that comes from the contact between finger and keys. In touch screens, the sensorial information that the phone provides for indicating the position of the fingers is showing an image with the key that is being pressed, said image being shown at a certain distance so that it is not covered by the user's finger and he/she can see it. This is the approach taken both by the iPhone and the Android devices.

The problem is that this information about the key that is being selected at each moment is not as effective as the sensorial information that is collected when the finger feels the keys on which it is lying. The consequence is that the users write more slowly, usually need two fingers and they make more mistakes.

For the time being, there is not a good solution that gives touch screen keyboards a similar usability qualities as conventional keyboards.

### EXPLANATION OF THE INVENTION

The invention's goal is to facilitate the utilization of touch screen devices, particularly for data entry, such as text and other characters.

For that purpose, it solves the main disadvantage of touch screens when compared to conventional keyboards. This disadvantage is that the touch screen does not provide sensorial information about the position on the keyboard in which the fingers is located.

The invention is based on creating some uneven areas over the surface of the touch screen on the positions where the keys will appear. These uneven areas will transmit sensorial information to the user, that that will assist him/her to make better use of the device, because he/she will be able to move the fingers with more agility and security.

The uneven areas that are created in order to transmit sensorial information to the user are basically of two types: external area, which is based on a protuberance, and the internal area, which is based on a depression.

External areas have the secondary effect that the increase the distance between finger and screen, which makes it harder for the device to detect the finger, and because of that they must be designed with care. However, if their extension is not very big, the finger will touch the screen around the perimeter of the area, which will facilitate the touch screen to detect the presence of the finger.

The internal area shows the opposite circumstance. When the finger presses on the internal area, it will be easier for the touch screen to detect that action.

As will be explained in the description of the preferred embodiment, in a particular embodiment, the areas could be transparent or opaque. In the case in which they are transparent and are fixed, they should be as small and thin as possible in order not to seriously damage the quality of vision. In general, they can be very thin, given that the finger tip has much sensitivity. For example, the fingers are easily capable to perceive the thickness of a hair that is being kept between two fingers.

The advantage of the invention for the user is that the fingers will move on the touch screen faster and more securely, because:
1. When moving on the surface, the information that provided by the areas that they cover will provide information to the brain about the path that the finger has transverse, having less need to look at the keyboard.
2. When resting on several keys at the same time, the finger will detect the relative position that it is occupying on the different keys on which it is lying. When this information combined with the information that is provided by the eyes, the user can better detect the relation between the finger and the key he/she wishes to press.
3. With the previous guide, the finger can rotate or lean over the screen in the way it needs, to make sure that the pressure that it exerts will in fact fall over the destination key.

### DESCRIPTION OF THE DRAWINGS

FIG. 1 shows an external area.

FIG. 2 shows an internal area

FIG. 3 schematically shows a basic embodiment of the invention

FIG. 4 schematically shows a basic embodiment of the invention.

FIG. 5 schematically shows a particular aspect of the preferred embodiment of the invention.

FIG. 6 shows an alternative embodiment in which the sheet does not cover all the screen.

FIG. 7 shows an alternative embodiment in which the keyboard is in longitudinal position.

FIG. 8 shows an alternative embodiment in which the sheet closes longitudinally.

FIG. 9 shows an alternative embodiment in which the sheet slides.

FIG. 10 shows an alternative embodiment based on a cover or housing that contains the sheet that can host the touch screen device.

FIG. 11 shows an alternative embodiment which is based on adding multiple individual areas.

FIG. 12 shows two types of uneven areas.

### DESCRIPTION OF ONE EMBODIMENT

### Description of the Preferred Embodiment

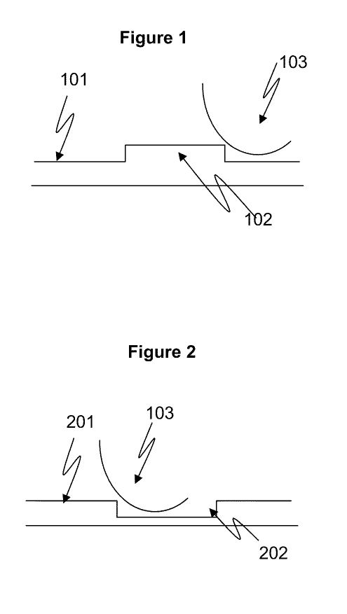

As has been mentioned, the uneven areas that are created to transmit sensorial information to the user basically are of two types: external area, based on a protuberance, and internal area, based on a depression. Both of them are respectively shown in FIGS. 1 and 2.

It FIG. 1, it can be seen that on the surface of the touch screen 101 there exists a certain external area 101 that provides sensorial information to finger 103. The opposite situation is shown in FIG. 2, in which there is an internal area. It must be noted that the representations shown in these figures have only the purpose to facilitate the description of the invention, given that the concrete design of the areas could be different.

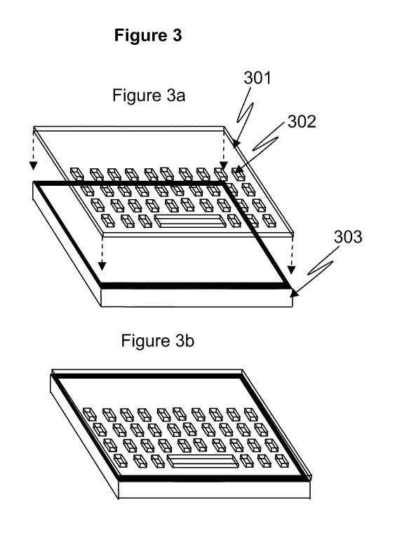

In the preferred embodiment, the invention is built after a thin sheet 301 that in this embodiment is a transparent sheet on which some internal areas 302 have been created, as shown in FIG. 3a. Said internal areas are basically ‘holes’ on the sheet 301. The objective making this ‘holes’ on the sheet 301 is making the sheet thick enough to be resisting, but facilitating the touch screen perceive the contact of the fingers when the finger is resting on one of the areas. Given that the areas go through the sheet, when a finger lies over it, it will get in direct contact with the touch screen and will be detected. In case the screen is sensitive enough, it is possible to use internal areas that do not go through the sheet. This will prevent dust to fall on the screen and stain it in the parts where the holes are.

Deciding the thickness of the sheet (which will be in relation to the strength of the sheet) and the type of area (external or internal, and if it is internal, whether it goes through the sheet) is a matter of design. This will depend on the material that is used for the sheet and on the sensitivity of the screen.

In this explanation it will be assumed, without loss of generality, that the embodiment is done on a mobile phone, but the invention might also embodied in a different type of device.

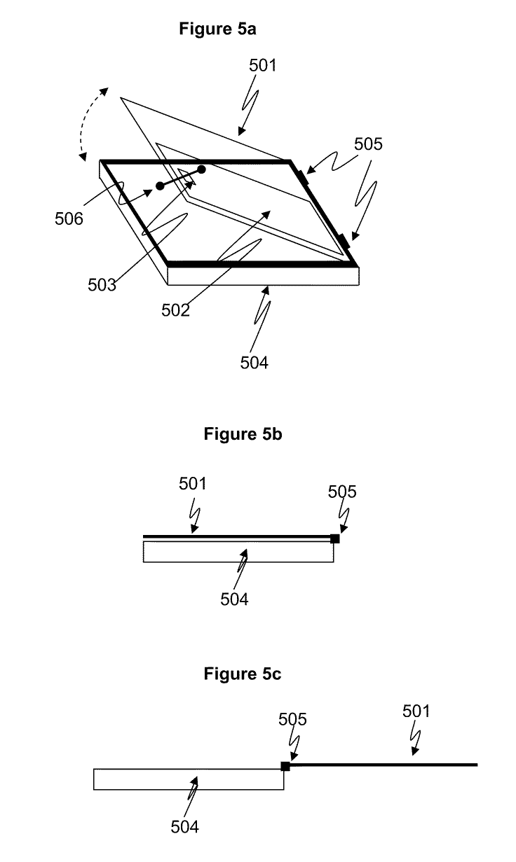

When the sheet 301 is placed on the mobile device 303 it will result in the situation that is shown in FIG. 3b. This way of joining is merely schematic and has the purpose of facilitating the explanation of the invention. Later on, in FIG. 5, the real way of joining the sheet with the device.

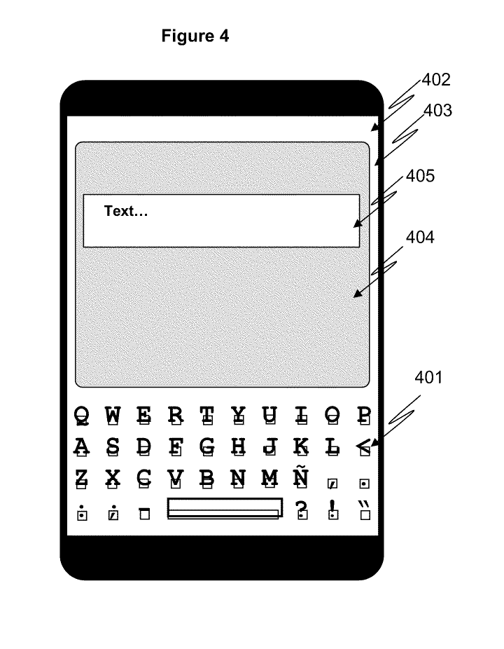

FIG. 4 shows a more realistic image of how a touch screen phone would look when the preferred embodiment of the invention is applied on it. It can be seen that there exist some small squares 401 over the keys, and said squares 401 correspond to the uneven areas that have been created on the transparent sheet 402, which is placed over the touch screen 403. In the touch screen there exist an active part 404 where some general information is shown to the user, and there exists a text box 405 where the characters chosen by the user are shown.

FIG. 4 is schematic and its purpose is showing the essence of the invention, due to which some usual components in mobile devices are not shown.

FIG. 5a shows how to join the transparent sheet with the mobile phone. The Figure show sheet 501 and the part 502. The uneven areas will be created on them to be placed over the keys. A single uneven area 503 has been represented in the Figure, and the other ones have been omitted. As was said before, the uneven area 502 will be a full opening, and the segment 506 has been included to indicate it. The sheet 501 is joined to the device 504 by hinges 505.

In general, it must be taken into account that there exist many ways to build the hinges that will be join sheet 501 with the mobile phone. Also, the hinges could also have some mechanisms, such as a spring to make the sheet to have two stable positions: open and closed. Given that this matter is something usual in the industry, it will not be discussed in this document.

As is described below, the user would use the invention in two different ways, depending on whether the sheet 501 is:
In open position, that is to say, placed over the device surface, as shown in FIG. 5b.
In close position, so that the user has direct access to the surface of the device, as shown in FIG. 5c
   The phone would have capacity to detect whether the sheet 501 is open or closed, and the software would behave differently in each case, as explained below.

When sheet 501 is closed, that is to say, placed over the surface, the mobile phone would look like in FIG. 4. The phone would detect that the sheet is closed, and the software would show in each moment any information as if the phone had a full external keyboard, similar to the case of Blackberry 9000. The part 404 would show the information relevant for the user. The keys would be shown in the bottom part, and they would be visible through the sheet 501, and would be detectable through the touch sense thanks to the uneven areas in sheet 501. In this situation, the user could use the phone in a similar way to the way a phones like Blackberry 9000 or Nokia E71 are used.

When the user wants to see in a larger display the information that appears in the screen, and without interference created by the uneven areas in sheet 501, he/she can open the sheet 501 and use the device in open position.

In open position, the user can watch all the touch screen. The phone would detect the change in position of the sheet 501, and would show the information in the same was as it is shown in a touch screen phone such as the iPhone. In open position, the user would use the device as if it was a touch screen device similar to the iPhone.

### DESCRIPTION OF OTHER EMBODIMENTS

In an alternative embodiment that is shown in FIG. 6, the transparent sheet 601 does not cover all the touch screen, but it is smaller and it only covers the keyboard. In the Figure, a single uneven area 603 has been drawn.

In a variation of this embodiment, the sheet 601 is not transparent, but it is opaque, and it has a keyboard printed on top of it, and in each key there exist an uneven area that provides sensorial tactile information to the user. In this embodiment, there exist keys that correspond to several characters, as usually happens in mobile phones, so that there exist several character sets for the keyboard. There exist other keys that are used to choose one or other character set. In this embodiment, the keys would be placed in an aligned fashion with the parts of the touch screen that the mobile phone interprets as keys.

In yet another variation that employs an opaque sheet, the uneven areas are flexible, and the depress when they are pressed. This facilitates that the touch screen detects the user action of choosing a key, because the finger would be closer to the sensitive surface. There exist many ways to make flexible uneven areas, such as for example with areas of ‘bubble’ type, which will yield under pressure. It is also possible to use cushion materials, or even real physical keys.

In the previous cases, the design of the system must take into account that the thickness of the sheet and of the uneven areas should not prevent the touch screen to detect the pressure of the fingers over it.

In another possible embodiment, the keys are in fact real physical keys, which also detect the pressure and transmit that information to the mobile phone via a connection that might be deployed through the hinges 605.

In another variation, the sheet is itself a tactile surface, with capacity to detect the position of the fingers.

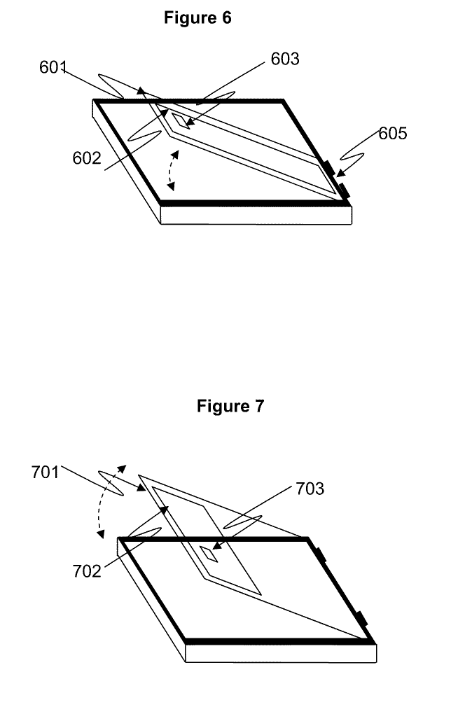

In another embodiment, shown in FIG. 7, keyboard 702 is in horizontal position, that is to say, along the long side of the phone. As in the previous cases, only one key 703 has been represented.

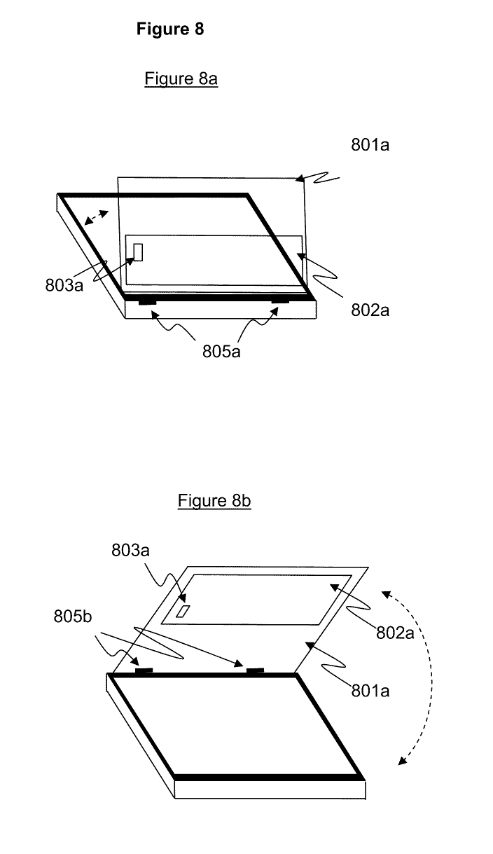

In other embodiments, shown in FIG. 8, the hinges 805 are placed in one of the short sides instead of being on the long side, and therefore the sheet 801 opens and closes in along the longitudinal direction. The sheet 801 can be on the bottom part, or on the upper part, as in a note pad.

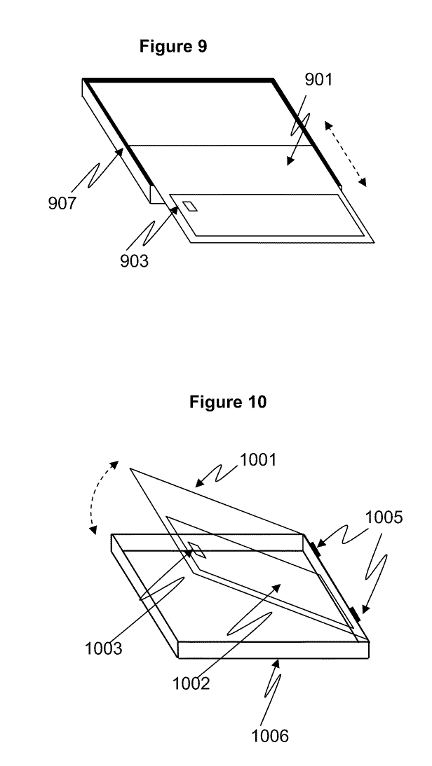

In other embodiment, shown in FIG. 9, the sheet 901 does not close by coming down on top of the surface, but it slides along rails 907. As in the case of FIG. 8, the sheet 901 could slip downwards or upwards, even though in FIG. 9 only the upwards embodiment has been shown. The precise form to create rails 907 along which the sheet slides is considered to be a matter of design, and is not described in this document. As in the previous cases, there could be variations on this embodiment, in which the sheet would have smaller size and would not cover the whole screen; or in which the keyboard in the other direction and the sliding sheet is in the perpendicular direction. Also, the sheet can be transparent or opaque. In order to facilitate the description of the embodiment, in this document the term “hinges” will be used both for hinges 505 in FIG. 5 as for rails 907 of FIG. 9. That is to say, the term “hinges” will be used to generically refer to the elements that allow to join the sheet (the element 505 and 905 in FIGS. 5 and 9 respectively) with the rest of the device, and which allow the sheet to be in open or close position. The sheet will bee in open position when the touch screen is directly visible, and in closed position when the screen is covered by the sheet. The action by which the sheet changes from one position to the other will be called “open” or “close”.

In another embodiment, shown in FIG. 10, the invention is built as a cover or housing into which the telephone can be inserted. That housing also has a sheet 1001 on which the uneven areas are places. This housing can be similar for example to one of those protective plastic covers that are usually employed to protect mobile phones, but it would also contain the sheet that has the uneven areas. The sheet and the way to put it into the housing can be any of the types previously described.

In another set of embodiments, the uneven areas cannot be separated from the touch screen. That is to say, they are always present even though they might slightly reduce the quality of the vision because the user might be seen the contour of squares 401. In these cases the uneven areas are made so that they bother as little as possible The materials will be thin and the border will be cut in a precise manner.

In one of these embodiments with fixed uneven areas, the transparent sheet 301 is an adhesive patch that will stick to the touch screen of the telephone. The final result is like shown in FIG. 3b, that is, it is not possible to remove the sheet 301. The uneven areas 302 will be of internal type. The final result is that the uneven areas are always present over the touch screen, independently of what the user is watching. The uneven areas will bother more or less depending on the application that the user is using. They will bother less if the user is watching video, but they will bother more for reading text, for example in a web page.

Even though the uneven areas could slightly distort the image on the touch screen, many users will accept this little distortion in exchange for higher speed and security when entering text. The user will have to evaluate the advantage of writing faster compared to the inconvenience of reading with more difficulties.

The telephone will have two modes of operation, and will be able the choose among them. In one mode, the phone will work in a vertical fashion, as in FIG. 4. In the other mode, the telephone will word occupying the whole touch screen. Inn this way, the user can have a telephone with a similar structure to Blackberry 9000's or Nokia E71's, but when he/she wishes watch videos on a larger screen, he will be able to switch modes, because the uneven areas do not interfere much with video watching.

The patch is created in the same material as the transparent plastic patches that are used to protect tactile screens. It is very difficult to tell whether a touch screen is protected by one of these patches, which shows that they interfere little with the transmission of luminosity and color of the screen.

To build this embodiment, the first step will be a plastic sheet in which the appropriate uneven areas have been created on the small parts that will aligned with the keys. In order to avoid the uneven areas to go through the transparent sheet, one solution is to make a transparent sheet after attaching two sheets to each other: one of them will have full perforations, and the other one will have no perforations In this fashion, the resulting sheet will be attached to the device's screen.

The advantage of this approach is that it can be applied to all the touch screens that already exist, only designing the plastic sheets in an appropriate way.

In other similar embodiment, the uneven areas will be complete, i.e. they will completely go through the transparent sheet 301.

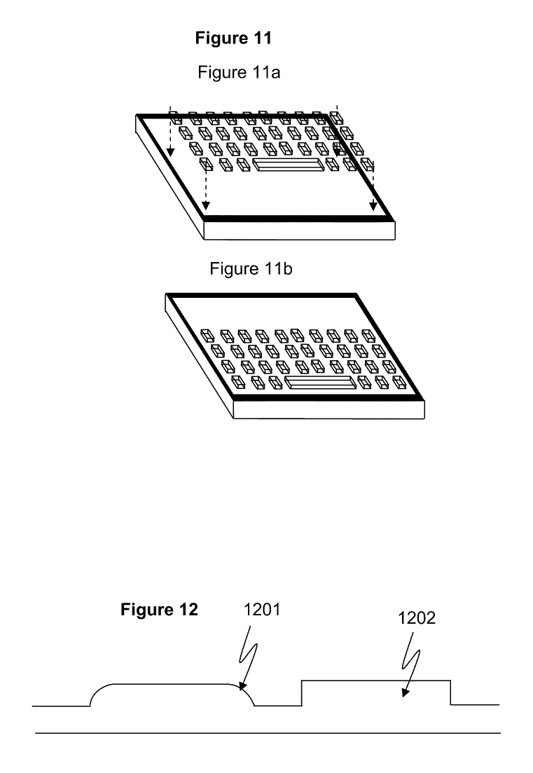

In other embodiment similar to the previous one, instead of attaching a sheet that has holes, several small patches will be stuck on the position of the keys, as shown in FIGS. 11a, and 11b. The uneven area created by those small patches will be detected by the finger when it gets in touch with the screen in that part.

In this case, the start point is also a sheet on which some precuts have been made on those parts where the patches will be located. That sheet will be adhered to the screen, and in the next step it will be remove by pulling from one extreme, so that the little patches will remain over the sheet of the touch screen.

This embodiment has the disadvantage that there is the possibility that the patches, being smaller, can get separated from the surface as a result of the contact with other objects, such as for example a key holder that might be kept in the same place as the device. Also, because the patches will be between the finger and the touch screen, they will make it a bit more difficult to detect the finger when it is intending to detect a key.

In another embodiment of the invention, the screen itself has been made by generating certain uneven areas in those parts where the keys will be placed. This embodiment has the disadvantage that it is not valid for already existing devices. Also, they fix the position of the keys, so that they allow less freedom for the software that might be run. When the uneven areas can be removed and put just by adhering a different sheet, it is possible to make sure that the software and the uneven areas will be adapted in the best possible way. For example, it is possible that a person would like for the keyboard to take up more or less room, which can be obtained by changing the software and attaching a sheet 301 with a different design for its uneven areas.

In another embodiment, the uneven areas which are placed over the screen have rounded edges, so that they have a different effect on the rays of lint, and can distort less the vision, as is depicted in FIG. 12. In that Figure, the rounded edge 1201 is compared with the sharp edge 1202.

In other embodiment, the uneven areas are created with a bubble shape. They are elastic, and when pressing with a finger they depress.

In other embodiment, not all the keys in the keyboard are associated to an uneven area. It might happen, for example, that the uneven areas are alternating with the keys, so that a key might have an uneven area, and the next key might not. This would reduce the number of uneven areas, even though it would also reduce the sensorial information that would be sent to the user.

In general, as has been mentioned, the uneven areas can be placed in vertical or horizontal position.

In all cases an example keyboard has been shown. It is understood that this is not limitative for the invention, and that the invention can use indistinctly the character used in the keyboard or keyboards that might be shown on the touch screen.

1. A touch screen device which comprises a number of uneven areas which are positioned over said touch screen in an aligned way with the keyboard that said touch screen will at some point show

2. The device in claim 1, wherein said uneven areas are created in the same material as the material of said touch screen.

3. The device in claim 1, wherein said uneven areas are created with patches made of a transparent material that can be adhered over said screen of said device.

4. The device in claim 1, wherein said device has two modes of operation, one of which takes into account the presence of said uneven areas and the other ones does not take said presence into account.

5. The device in claim 1, wherein:
said uneven areas are placed over a sheet,
said sheet is placed over said screen.

6. The device in claim 5, wherein:
said sheet is joint to said device by hinges,
said sheet can move and can be in an open or closed position.

7. The device in claim 5, wherein said sheet is opaque.

8. The device in claim 5, wherein said uneven areas are elements that have been added upon said sheet.

9. The device in claim 8, wherein said elements are flexible, that is, they yield under pressure.

10. The device in claim 5, wherein said sheet comprises graphical elements which are aligned with said uneven areas to facilitate its utilization

11. The device in claim 5, wherein said sheet can be adhered to the surface of said device

12. A sheet of material which can be used as the sheet in claim 5

13. Method for entering data in a touch screen device characterized by adding a set of uneven areas over the touch screen of said device, so that said uneven areas are aligned with the keys of a keyboard that shows on said touch screen.

14. The method in claim 13 wherein said uneven areas are created in the same material as the material of said touch screen.

15. The method in claim 14, wherein said uneven areas are created with patches made of a transparent material that can be adhered over said screen of said device.

16. The method in claim 13 where in adding said uneven areas comprises the steps of:
creating said uneven areas over a sheet,
attaching said sheet over said touch screen.

17. The method of claim 16, further comprising the step of adding hinges that join said sheet to said device, So that said sheet can move and be in open or closed position.

18. The method in claim 16, wherein said sheet is opaque.

19. The method in claim 16 wherein said uneven areas are elements that have been added upon said sheet.

20. The method in claim 19, wherein said elements are flexible, that is, they yield under pressure.
